(19) United States
(12) Patent Application Publication
(10) Pub. No.: US 2019/0286416 A1
(43) Pub. Date: Sep. 19, 2019

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJI XEROX CO., LTD., Tokyo (JP)

(72) Inventor: Atsushi ITO, Kanagawa (JP)

(73) Assignee: FUJI XEROX CO., LTD., Tokyo (JP)

(21) Appl. No.: 16/294,965

(22) Filed: Mar. 7, 2019

(30) Foreign Application Priority Data
Mar. 16, 2018 (JP) 2018-048983

(51) Int. Cl. G06F 7/08; G06F 16/27

(52) U.S. Cl. CPC G06F 7/08; G06F 16/27

(57) ABSTRACT

An information processing apparatus includes an acquisition unit that acquires plural pieces of data to be handled, and a sorting unit that sorts the plural pieces of data acquired by the acquisition unit so that data having a property different from properties of other pieces of data is located at a higher place.

### CROSS-REFERENCE TO RELATED APPLICATIONS

This application is based on and claims priority under 35 USC 119 from Japanese Patent Application No. 2018-048983 filed Mar. 16, 2018.

### BACKGROUND

### (i) Technical Field

The present disclosure relates to an information processing apparatus, an information processing system, and a non-transitory computer readable medium storing a program.

### (ii) Related Art

Japanese Unexamined Patent Application Publication (Translation of PCT Application) No. 2005-506617 discloses a system for data quality management and control of heterogeneous data systems as a resource management tool that simplifies the process of managing data systems. The system includes at least one portal including a plurality of data viewers each having access to data sources and configured to analyze data in the data sources and display the results of the analysis. Each portal has one or more of management features that are “create”, “save”, “open”, “edit”, “merge”, and “destroy”. The system allows users to view data structures and facilitates management and manipulation of data that may be contained within heterogeneous data systems.

Japanese Unexamined Patent Application Publication No. 2008-152782 discloses a system that extracts data across a plurality of business applications and applies a predetermined rule to check whether the extracted data matches a business rule, thereby detecting a procedural deficiency across the plurality of business applications.

### SUMMARY

Aspects of non-limiting embodiments of the present disclosure relate to an information processing apparatus, an information processing system, and a non-transitory computer readable medium storing a program, in which, when a plurality of pieces of data are sequentially processed, a period of time ranging from the start of processing to the occurrence of an error in the processing of any piece of data may be shortened compared with a case in which the pieces of data are processed in the original order.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising an acquisition unit that acquires a plurality of pieces of data to be handled, and a sorting unit that sorts the plurality of pieces of data acquired by the acquisition unit so that data having a property different from properties of other pieces of data is located at a higher place.

### BRIEF DESCRIPTION OF THE DRAWINGS

An exemplary embodiment of the present disclosure will be described in detail based on the following figures, wherein:

FIG. 1 illustrates an example of an information processing system according to one exemplary embodiment of the present disclosure;

FIG. 2 illustrates the hardware configuration of an information processing apparatus according to the exemplary embodiment of the present disclosure;

FIG. 3 illustrates functional blocks of the information processing apparatus of FIG. 2;

FIG. 4 illustrates the hardware configuration of a data server according to the exemplary embodiment of the present disclosure;

FIG. 5 illustrates functional blocks of the data server of FIG. 4;

FIG. 6 illustrates an example of a database stored in a data storing part of the data server according to the exemplary embodiment of the present disclosure;

FIG. 7 is a flowchart illustrating a flow of an operation to be performed when the information processing apparatus sorts the database according to the exemplary embodiment of the present disclosure;

FIG. 8 illustrates a state of a sorted replicated database;

FIG. 9 is a flowchart illustrating a flow of an operation to be performed when the information processing apparatus manipulates the database according to the exemplary embodiment of the present disclosure; and

FIG. 10 is a flowchart illustrating a detailed flow of the manipulation of the replicated database in Step S904 of FIG. 9 or the manipulation of the database in Step S905.

### DETAILED DESCRIPTION

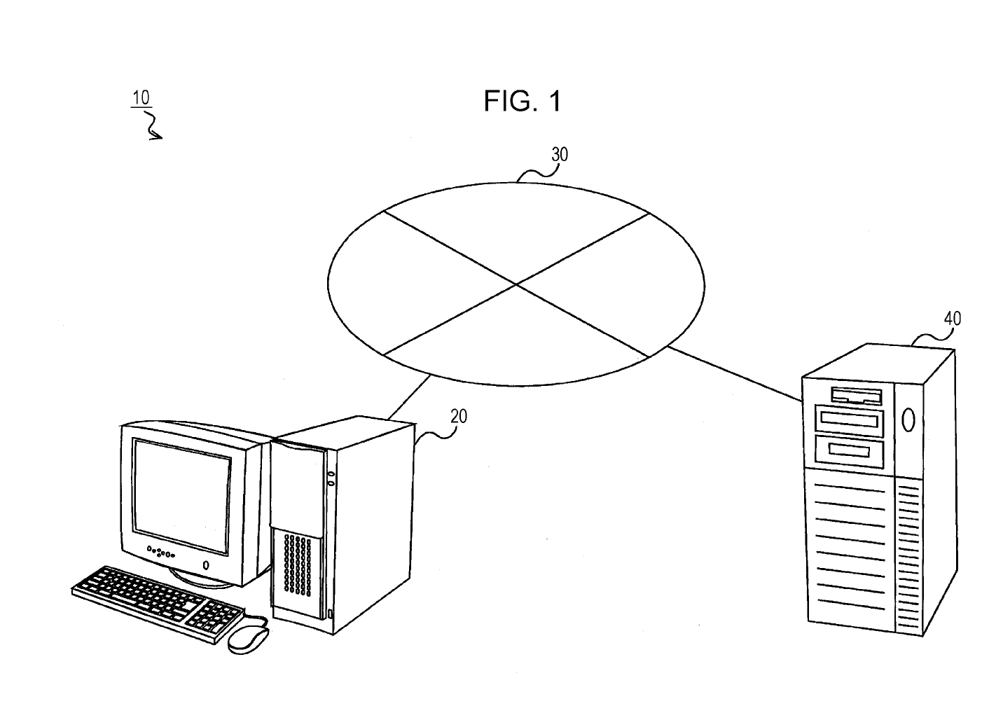

An information processing system 10 according to one exemplary embodiment of the present disclosure is described with reference to FIG. 1. FIG. 1 illustrates the system configuration of the information processing system 10 according to the exemplary embodiment of the present disclosure. As illustrated in FIG. 1, the information processing system 10 is configurated by an information processing apparatus 20 and a data server 40 connected to the information processing apparatus 20 via a network 30 such as the Internet.

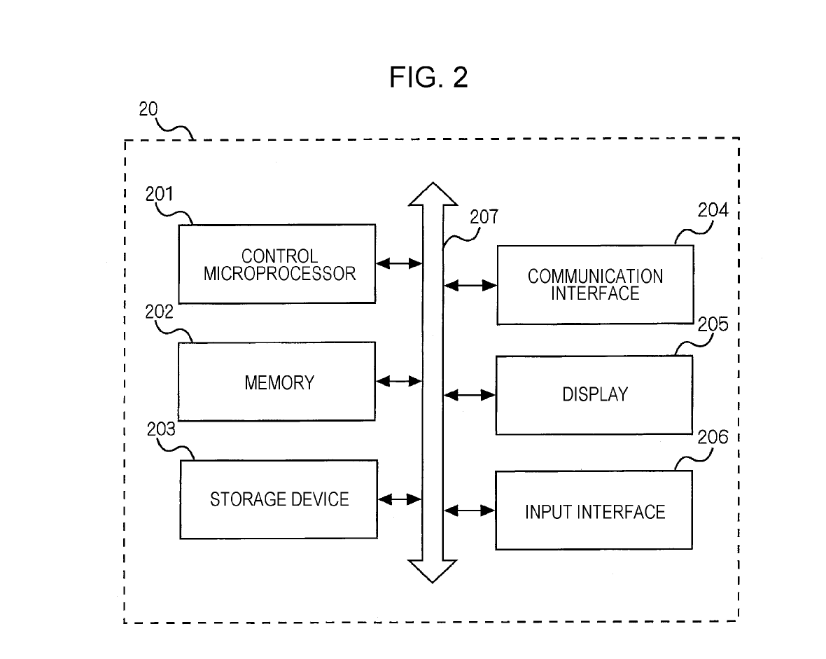

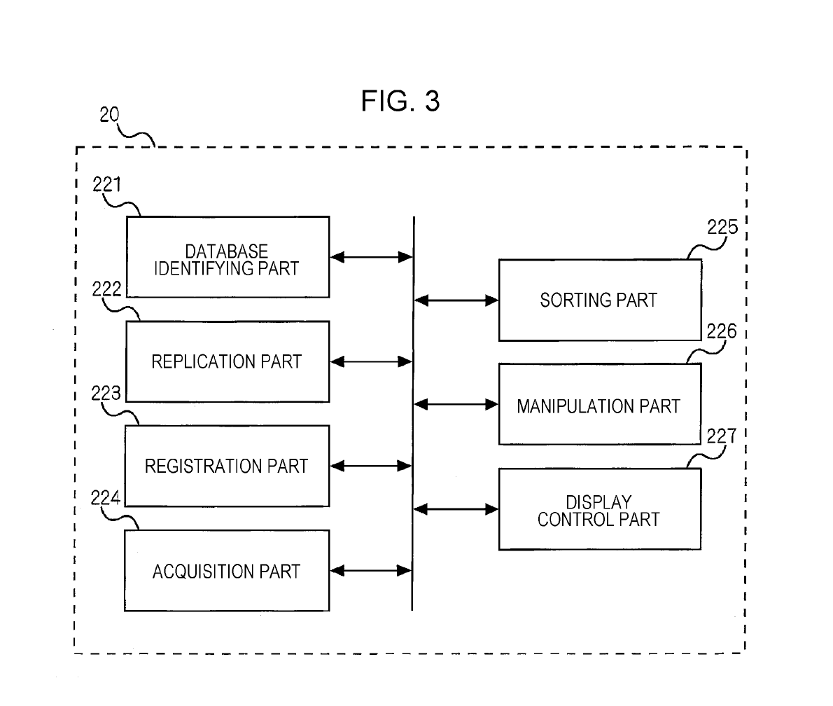

Next, the configuration and functions of the information processing apparatus 20 are described with reference to FIG. 2 and FIG. 3. FIG. 2 illustrates the hardware configuration of the information processing apparatus 20 according to this exemplary embodiment. For example, the information processing apparatus 20 is a desktop computer but is not limited thereto. The information processing apparatus 20 may be a notebook computer or any other terminal apparatus as long as the information processing apparatus 20 has the following configuration.

As illustrated in FIG. 2, the information processing apparatus 20 includes a control microprocessor 201, a memory 202, a storage device 203, a communication interface 204, a display 205, and an input interface 206. Those components are connected to a control bus 207.

The control microprocessor 201 controls operations of the respective parts of the information processing apparatus 20 based on a control program stored in the storage device 203.

The memory 202 temporarily stores data acquired by an acquisition part described later.

The storage device 203 is a hard disk drive (HDD) or a solid-state drive (SDD) and stores the control program for controlling the respective parts of the information processing apparatus 20.

The communication interface 204 performs communication control so that the information processing apparatus 20 communicates with the data server 40 via the network 30.

The display 205 is a liquid crystal display integrated with or separate from the information processing apparatus 20 and displays information processed by a display control part described later.

The input interface 206 is input means such as a keyboard or a mouse to be used for inputting an instruction by an operator who operates the information processing apparatus 20.

Next, the functions of the information processing apparatus 20 according to this exemplary embodiment are described with reference to FIG. 3. FIG. 3 illustrates functional blocks of the information processing apparatus 20 of FIG. 2. As illustrated in FIG. 3, the information processing apparatus 20 is configurated to include functions of a database identifying part 221, a replication part 222, a registration part 223, an acquisition part 224, a sorting part 225, a manipulation part 226, and a display control part 227 by causing the control microprocessor 201 to execute the control program stored in the storage device 203.

When the operator who operates the information processing apparatus 20 specifies a database to be sorted, for example, specifies the data server 40 and a database name by operating the input interface 206, the database identifying part 221 refers to a data storing part of the data server 40 described later and identifies a host name, a port number, and the database name of the database to be sorted. For example, the operator may specify the name of the database to be sorted. Alternatively, the operator may specify the data server 40, cause the information processing apparatus 20 to acquire and display a list of database names stored in the data server 40, and select the name of the database to be sorted from the list of database names. When the operator specifies a name of a database to be manipulated or the data server 40 by operating the input interface 206 after the database has been sorted, the database identifying part 221 refers to association information registered in the data storing part of the data server 40 and identifies the name of the database to be manipulated (replicated database) and a host name and a port number thereof. After the database identifying part 221 has identified the location of the database to be sorted or manipulated, the database identifying part 221 transmits a request for connection to the database in response to an operator's instruction.

The replication part 222 transmits, to the data server 40, an instruction to replicate the database that is stored in the data storing part of the data server 40 and is identified by the database identifying part 221 as the database to be sorted, thereby replicating the database. The replication part 222 stores the new replicated database in the data storing part of the data server 40. The replicated database need not be stored in the data storing part of the data server 40 but may be stored in the information processing apparatus 20 or any other data server (not illustrated) connected to the network 30.

When the database to be sorted is replicated by the replication part 222, the registration part 223 generates association information in which database information including the host name, the port number, and the database name of the database to be sorted and a connecting user name and a password with which connection is permitted is associated with replicated database information including the host name, the port number, and the database name of the replicated database that is replicated by the replication part 222 and a user name and a password with which connection is permitted. The registration part 223 registers the association information in the data storing part.

The acquisition part 224 acquires a plurality of pieces of data included in the replicated database obtained by replicating the database to be handled, that is, sorted. Specifically, the acquisition part 224 sequentially acquires the plurality of pieces of data included in the replicated database and stores the pieces of data in the memory 202 for processing to be performed by the sorting part 225 described later. Further, the acquisition part 224 sequentially acquires the plurality of pieces of data included in the sorted replicated database to be manipulated and stores the pieces of data in the memory 202 for processing to be performed by the manipulation part 226 described later. To sequentially acquire the plurality of pieces of data when the database to be sorted or manipulated includes a plurality of records, the records may sequentially be acquired one by one or the plurality of records may be acquired at a time.

The sorting part 225 sorts the plurality of pieces of data acquired by the acquisition part 224 so that data having a property or attribute different from those of the other pieces of data is located at a higher place. Then, the sorting part 225 overwrites the replicated database. Details of the sorting method are described later.

When the operator has specified a certain database to be manipulated, the manipulation part 226 causes the database identifying part 221 to identify a corresponding sorted replicated database by referring to association information registered in the data storing part of the data server 40, causes the acquisition part 224 to sequentially acquire a plurality of pieces of sorted data included in the replicated database, and sequentially manipulates the plurality of pieces of acquired data. The manipulation may be started in response to an operator's instruction or may automatically be executed subsequently to the sorting described above.

The display control part 227 displays the data acquired by the acquisition part 224 on the display 205 of the information processing apparatus 20 by a display method such as a matrix-like table format. When the plurality of pieces of data included in the database are sorted by the sorting part 225, the display control part 227 generates a message indicating that the sorting is in progress or a message for notifying the operator of the progress of the sorting and displays the message on the display 205. When the manipulation is performed by the manipulation part 226, the display control part 227 generates a message indicating that the manipulation is in progress or a message for notifying the operator of the progress of the manipulation and displays the message on the display 205. When a processing error has occurred during the manipulation performed by the manipulation part 226, the display control part 227 generates a message indicating that the error has occurred and displays the message on the display 205.

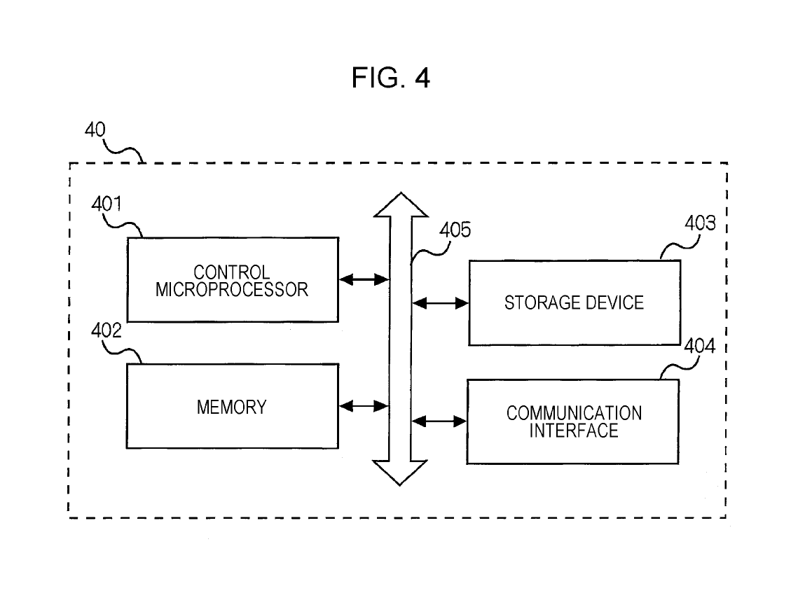

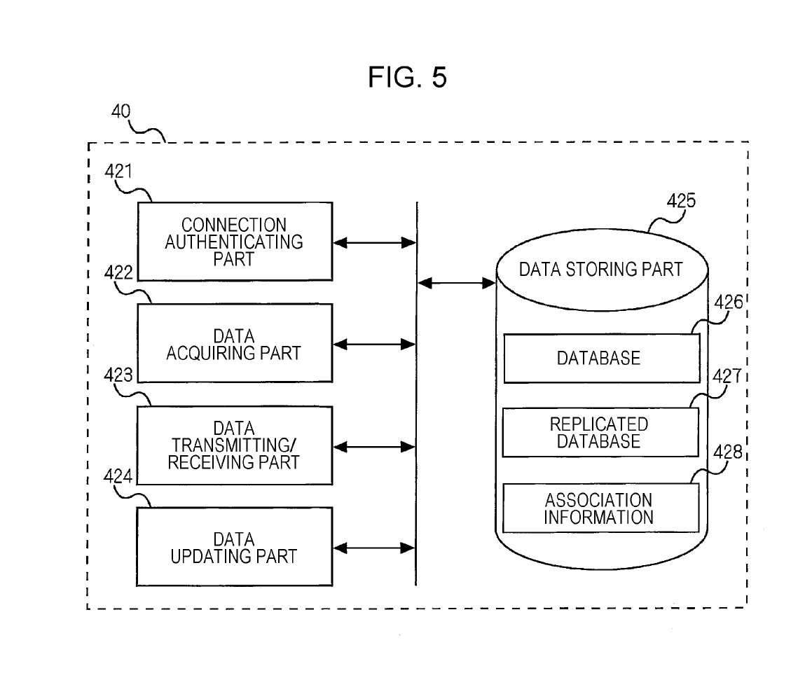

Next, the configuration and functions of the data server 40 of the information processing system 10 according to the exemplary embodiment of the present disclosure are described with reference to FIG. 4 and FIG. 5. FIG. 4 illustrates the hardware configuration of the data server 40 according to this exemplary embodiment. For example, the data server 40 is a server computer but may be a desktop computer or a cloud server.

As illustrated in FIG. 4, the data server 40 includes a control microprocessor 401, a memory 402, a storage device 403, and a communication interface 404. Those components are connected to a control bus 405. The data server 40 may further include a display or an input interface but those components are not necessary for the data server. The operator may connect the information processing apparatus 20 to the data server 40 and perform display processing and an input operation by using the display 205 and the input interface 206 of the information processing apparatus 20.

The control microprocessor 401 controls operations of the respective parts of the data server 40 based on a control program stored in the storage device 403.

For example, the memory 402 temporarily stores connection information such as a user name and a password included in a connection request received from the information processing apparatus 20, data acquired from a database by a data acquiring part 422, and a plurality of pieces of data sorted by the sorting part 225 of the information processing apparatus 20.

The storage device 403 is a hard disk drive (HDD) or a solid-state drive (SDD) and stores, for example, the control program for controlling the respective parts of the data server 40 and a database and a replicated database described later.

The communication interface 404 performs communication control so that the data server 40 communicates with the information processing apparatus 20 via the network 30.

Next, the functions of the data server 40 according to this exemplary embodiment are described with reference to FIG. 5. FIG. 5 illustrates functional blocks of the data server 40 of FIG. 4. As illustrated in FIG. 5, the data server 40 is configurated to include functions of a connection authenticating part 421, the data acquiring part 422, a data transmitting/receiving part 423, a data updating part 424, and a data storing part 425 by causing the control microprocessor 401 to execute the control program stored in the storage device 403.

When a database to be sorted or manipulated is identified by the database identifying part 221 of the information processing apparatus 20, the connection authenticating part 421 performs authentication as to whether to permit connection to the identified database by the information processing apparatus 20 and enable sorting or manipulation. When a connection request is received from the database identifying part 221 in response to an operator's instruction, the connection authenticating part 421 determines whether to permit connection to the database by using a user name and a password included in the connection request. When the user name and the password are valid, the connection authenticating part 421 permits the connection to the database by the information processing apparatus 20 and enables data acquisition from the database and data update.

When a request is made by the acquisition part 224 of the information processing apparatus 20 to acquire a plurality of pieces of data included in the database to be sorted or manipulated, the data acquiring part 422 sequentially acquires the plurality of pieces of data included in the database and temporarily stores the pieces of data in the memory 402.

The data transmitting/receiving part 423 transmits, to the information processing apparatus 20, the plurality of pieces of data acquired by the data acquiring part 422 in response to the data acquisition request made by the acquisition part 224 of the information processing apparatus 20. The data transmitting/receiving part 423 receives pieces of data sorted by the sorting part 225 of the information processing apparatus 20 and information on sorted positions thereof or receives a plurality of pieces of data processed by the manipulation part 226.

When an instruction to move data of a given record to a higher place in a replicated database 427 is received from the sorting part 225 of the information processing apparatus 20, the data updating part 424 moves the data of the record to a higher place in the replicated database 427, thereby sorting the plurality of pieces of data included in the replicated database 427.

The data storing part 425 stores a database 426, the replicated database 427, and association information 428. The database 426 is configurated by a plurality of records and columns and each of the records and columns includes a plurality of pieces of data. The replicated database 427 is a database obtained by replicating the database 426 by the replication part 222 of the information processing apparatus 20 described above. The association information 428 is information in which database information on the database 426 stored in the data storing part 425 is associated with database information on the replicated database 427. Specifically, the database information on the database 426 includes information for uniquely identifying the database, such as a host name of the data server that stores the database 426 and a database name, and information for establishing connection to the database, such as a port number for establishing connection to the database and a user name and a password with which connection is permitted. Similarly, the database information on the replicated database 427 includes information for uniquely identifying the replicated database, such as a host name of the data server that stores the replicated database 427 and a database name, and information for establishing connection to the replicated database, such as a port number for establishing connection to the replicated database and a user name and a password with which connection is permitted. The database identifying part 221 of the information processing apparatus 20 specifies the host name, the database name, the port number, and the like to uniquely identify the database to be processed.

The replicated database 427 need not be stored in the data storing part 425 of the data server 40 but may be stored in the storage device 203 of the information processing apparatus 20 or a data storing part of any other data server (not illustrated). In any case, when the database 426 before replication is specified, the corresponding replicated database 427 is uniquely identified as long as the database information on the database 426 before replication and the database information on the replicated database 427 are stored in association with each other as the association information.

In general, the data storing part 425 stores a plurality of databases. To make a concise description, this exemplary embodiment is directed to a case of storing one database 426 and one replicated database 427 obtained by replicating the database 426.

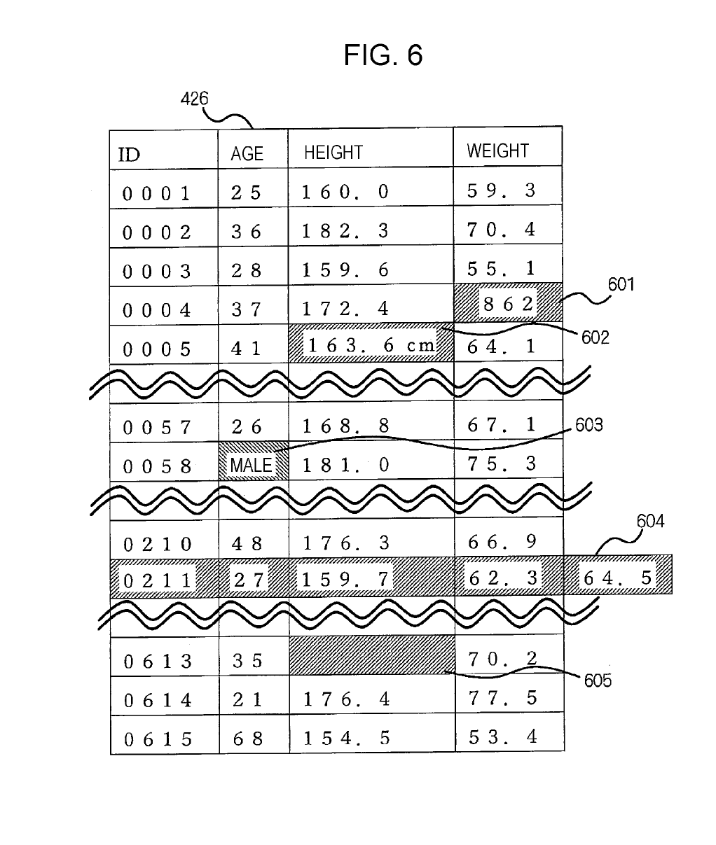

An example of the database 426 is described with reference to FIG. 6. FIG. 6 illustrates an example of the database 426 stored in the data storing part 425 of the data server 40 according to the exemplary embodiment of the present disclosure. The database 426 is configurated by a plurality of records and a plurality of columns. Each of the records includes a plurality of pieces of data and each of the columns also includes a plurality of pieces of data. Each of the records in the database 426 includes a plurality of data entries (fields) corresponding to the number of the columns and each of the data entries stores data.

For example, in the database 426 illustrated in FIG. 6, the number of records is “616” and the number of columns is “4”. The columns are configurated by items “ID”, “age”, “height”, and “weight”. For example, in a record including a data entry in which the value of the column “ID” is “0001”, the value of a data entry belonging to the column “age” is “25”, the value of a data entry belonging to the column “height” is “160.0”, and the value of a data entry belonging to the column “weight” is “59.3”. The database 426 may include a plurality of tables each configurated by a plurality of records and a plurality of columns. For convenience of the description, the following description is directed to a case in which the database includes a single table alone.

As illustrated in FIG. 6, the database 426 includes a plurality of pieces of data having properties different from those of the other pieces of data. For example, in a record including a data entry in which the value of the column “ID” is “0004”, the value of a data entry belonging to the column “weight” is “862”, which may be regarded as a statistical outlier. This phenomenon may be caused by an erroneous input when the database is created (data entry 601 of FIG. 6). In a record including a data entry in which the value of the column “ID” is “0005”, the value of a data entry belonging to the column “height” is “163.6 cm”, which includes unnecessary characters “cm” that is not included in the other data entries that configurate the column “height”. Therefore, the data type is different from data types of the other data entries of the same column (data entry 602 of FIG. 6). In a record including a data entry in which the value of the column “ID” is “0058”, the value of a data entry belonging to the column “age” is “male”, which is not a numeral of a data type of each data entry that configurates the column “age”. Therefore, this value may be regarded as a value of a different data type (data entry 603 of FIG. 6).

In a record including a data entry in which the value of the column “ID” is “0211”, the number of columns is “5”, which is different from the number of columns “4” of the other records that configurate the database 426 (record 604 of FIG. 6). In a record including a data entry in which the value of the column “ID” is “0613”, the value of a data entry belonging to the column “height” is left blank. Therefore, this record is a record including lost data (data entry 605 of FIG. 6).

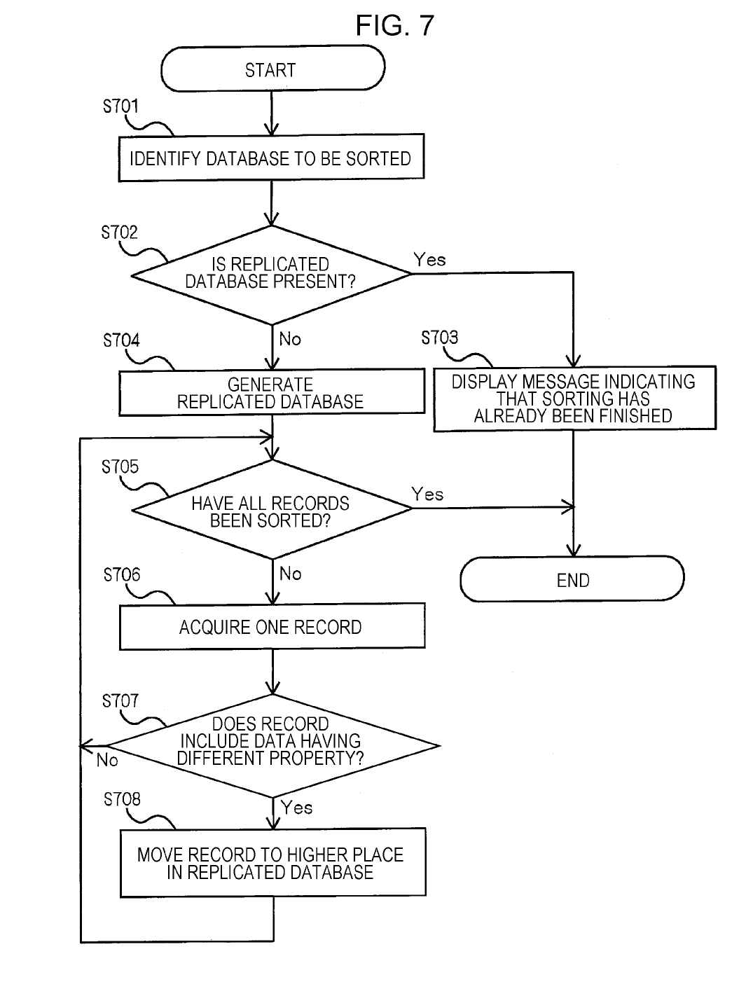

Next, an operation to be performed when the database 426 is sorted is described with reference to FIG. 7. FIG. 7 is a flowchart illustrating a flow of the operation to be performed when the information processing apparatus 20 sorts the database 426 according to the exemplary embodiment of the present disclosure.

In Step S701, the operator who operates the information processing apparatus 20 specifies the database 426 to be sorted by operating the input interface 206 while viewing information displayed on the display 205. Specifically, the operator specifies the database 426 by inputting the name of the database 426 through the operation for the input interface 206. Then, the database identifying part 221 searches the data storing part 425 of the data server 40 for the database having this name and identifies the database 426. Alternatively, the operator may specify the data server 40 by operating the input interface 206. In this case, the database identifying part 221 acquires names of a plurality of databases stored in the data storing part 425 of the data server 40 and the display control part 227 displays a list of the names of the databases. The operator specifies the name of the database 426 to be sorted from the list of the names.

When the specified database 426 is identified, the database identifying part 221 prompts the operator to input a user name and a password for connection to the database 426 to be sorted and requests the connection authenticating part 421 of the data server 40 to perform authentication by using the input user name and the input password as to whether to permit the operator to operate the database 426 to be sorted. When the authentication has failed, the sorting is not performed and the display control part 227 causes the display 205 to display a message indicating that the authentication has failed. Then, the processing is terminated. When the authentication is successful, the processing proceeds to Step S702.

In Step S702, the replication part 222 refers to the association information 428 stored in the data storing part 425 of the data server 40 and determines whether the replicated database 427 obtained by replicating the database 426 identified as a database to be sorted is already present. When it is determined that the replicated database 427 is already present, the processing proceeds to Step S703 and the display control part 227 generates a message indicating that the sorting has already been finished and displays the message on the display 205. Then, the processing is terminated. When it is determined in Step S702 that the replicated database 427 is not present, the processing proceeds to Step S704. If the replicated database 427 is present but a plurality of pieces of new data are added to the database 426 after the replicated database 427 has been generated, the database 426 includes pieces of unsorted data and therefore the processing proceeds to Step S704.

In Step S704, the replication part 222 instructs the data server 40 to replicate the identified database 426. When the data server 40 has received the instruction to replicate the database 426 from the replication part 222 of the information processing apparatus 20, the data acquiring part 422 sequentially acquires pieces of data (records) from the database 426 identified as a database to be sorted in the data storing part 425 and the data server 40 generates the replicated database 427 by copying the pieces of data in the data storing part 425.

The replicated database 427 need not be generated in the data storing part 425 of the data server 40. The information processing apparatus 20 may sequentially receive the pieces of data (records) of the database 426 that have been acquired by the data acquiring part 422 and the replication part 222 of the information processing apparatus 20 may generate the replicated database 427 by copying the pieces of data in the storage device 203 of the information processing apparatus 20. Alternatively, the pieces of data (records) of the database 426 may sequentially be transmitted to any other data server (not illustrated) connected to the network 30 and the replicated database 427 may be generated by copying the pieces of data in a storage device of the other data server.

Along with the generation of the replicated database 427, the registration part 223 associates a host name of the data server 40 that stores the database to be sorted, a database name, a port number, and a user name and a password with which connection is permitted with a host name of the data server that stores the replicated database 427 that is replicated by the replication part 222, a database name, and a port number. The registration part 223 registers those pieces of information in the data storing part 425 as the association information 428.

When the replicated database 427 is generated, the sorting part 225 determines in Step S705 whether all the plurality of pieces of data, that is, records included in the replicated database 427 have been sorted. When it is determined that all the records have been sorted, all the processing operations related to the sorting in FIG. 7 are terminated. When it is determined that all the records have not been sorted, the processing proceeds to Step S706.

In Step S706, the acquisition part 224 requests the data server 40 to acquire pieces of data included in one unsorted record included in the replicated database 427. In response to the request, the data acquiring part 422 of the data server 40 acquires the pieces of data included in one unprocessed record from the replicated database 427 in the data storing part 425 and the data transmitting/receiving part 423 transmits the pieces of data to the information processing apparatus 20. When the acquisition part 224 of the information processing apparatus 20 has acquired the pieces of data of the unprocessed record from the data server 40, the acquisition part 224 temporarily stores the pieces of data in the memory 202 (pieces of data of a plurality of records may be transmitted simultaneously).

In Step S707, the sorting part 225 determines whether data having a property different from those of the other pieces of data is included in the pieces of data included in the record acquired by the acquisition part 224.

The data having a property different from those of the other pieces of data includes data having a data structure different from those of the other pieces of data. Examples of the data having a data structure different from those of the other pieces of data include data in which the number of data entries belonging to a certain record is different from the numbers of data entries of most of the other records and data in which the data type of a data entry belonging to a certain column is different from the data types of the other data entries belonging to the same column.

The data in which the number of data entries of a certain record is different from the numbers of data entries of the other records includes data in which the number of data entries of a certain record is larger or smaller than the numbers of data entries of the other records. For example, in the database 426 of FIG. 6 (in actuality, the replicated database 427 is processed), the record in which the value of the column “ID” corresponds to “0211” is regarded as the data in which the number of data entries is different from those of the other pieces of data because the number of columns (“5”) is larger than the numbers of columns “4” of the other records.

The data in which the data type of a data entry belonging to a certain column is different from the data types of the other data entries belonging to the same column includes data in which the data type of a data entry belonging to a certain column is a numeral but the data types of the other data entries belonging to the same column are character strings.

The data described above also includes data in which the data type of a data entry belonging to a certain column is a character string but the data types of the other data entries belonging to the same column are numerals. For example, in the database 426 of FIG. 6, in the record in which the value of the column “ID” corresponds to “0005”, the value of the data entry belonging to the column “height” is “163.6 cm”. The values of the data entries belonging to this column in the other records are numerals but the value of the data entry belonging to this column in this record includes characters “cm” (is a character string). Therefore, the data of this record is regarded as the data whose data type is different from those of the other pieces of data. For example, in the record in which the value of the column “ID” corresponds to “0058”, the value of the data entry belonging to the column “age” is “male” but the values of the data entries belonging to this column in most of the other records are numerals. Therefore, the data of this record is regarded as the data whose data type is different from those of the other pieces of data.

When the value of a certain data entry falls out of a value range that is identified by using .a plurality of pieces of data of a column to which the data entry belongs and is appropriate for the pieces of data, data of a record including this value is regarded as the data having a property different from those of the other pieces of data.

For example, in the database 426 of FIG. 6, in the record in which the value of the column “ID” corresponds to “0004”, the value of the data entry belonging to the column “weight” is “862”, which deviates greatly from the values of the other pieces of data belonging to the column “weight” in most of the other records. Therefore, the value of this data entry is regarded as a value that falls out of the value range that is appropriate for the data of this data entry.

When the value of a certain data entry falls out of a statistical range calculated by using a plurality of pieces of data of a column to which the data entry belongs, data of the data entry including this value is regarded as the data having a property different from those of the other pieces of data. For example, the sorting part 225 defines a statistical range based on a normal distribution represented by using the values of all the data entries belonging to the column “weight” in the database 426 of FIG. 6. For example, deviations of the respective pieces of data are calculated based on the normal distribution under the assumption that the values of the pieces of data of all the data entries belonging to the column “weight” follow the normal distribution. It is determined that a record including data whose deviation falls out of a range of 10 to 90 is the data having a property different from those of the other pieces of data. The statistical range need not be determined based on the normal distribution but may be determined by using any other statistical distribution.

When the value of a certain data entry is blank data, the sorting part 225 determines that data of a record including the data entry having the blank data is the data having a property different from those of the other pieces of data. For example, in the database 426 of FIG. 6, in the record in which the value of the column “ID” corresponds to “0613”, the value of the field belonging to the column “height” is left blank. In actuality, this data entry is supposed to include numerical data indicating a so-called height and is therefore regarded as a data entry that falls out of the statistical range. It may be determined that data of a record including a data entry having no substantial value as the blank data, such as a space, a numeral “0”, or a mere symbol, is the data having a property different from those of the other pieces of data.

The data structure, the number of data entries, the data type, and the value range that are appropriate for the data entries belonging to the respective records may be set in advance in the database 426. Alternatively, when the replication part 222 generates the replicated database 427 by giving an instruction to replicate the database 426, the acquisition part 224 may identify, via the data acquiring part 422 of the data server 40, the data structure, the number of data entries, the data type, and the value range that are included in the database 426. When the values of data entries belonging to a certain column are numerals, the acquisition part 224 may statistically process the numerals of the plurality of data entries belonging to the column and identify a statistical range to which most of the numerals of the column belong. The acquisition part 224 may identify a statistical range that excludes extreme numerals.

When the sorting part 225 has determined in Step S707 that the data having a property different from those of the other pieces of data is included in the pieces of data of the record acquired by the acquisition part 224, the processing proceeds to Step S708.

In Step S708, the sorting part 225 sorts the plurality of pieces of acquired data so that the data having a property different from those of the other pieces of data is located at a higher place. Specifically, the sorting part 225 instructs the data server 40 to move, to a higher place, for example, a highest place in the replicated database 427, pieces of data of a record that is acquired by the acquisition part 224 and is determined as a record including the data having a property different from those of the other pieces of data. In response to the instruction, the data updating part 424 of the data server 40 moves, to a higher place in the replicated database 427, the pieces of data of the record including the data having a property different from those of the other pieces of data. Subsequently, the processing returns to Step S705 and the processing operations of Steps S705 to S708 are repeated until all the records are processed.

When it is determined in Step S707 that the data having a property different from those of the other pieces of data is not included in the pieces of data of the acquired record, the processing returns to Step S705 and the processing operations of Steps S705 to S708 are repeated for pieces of data of subsequent unprocessed records until all the records are processed.

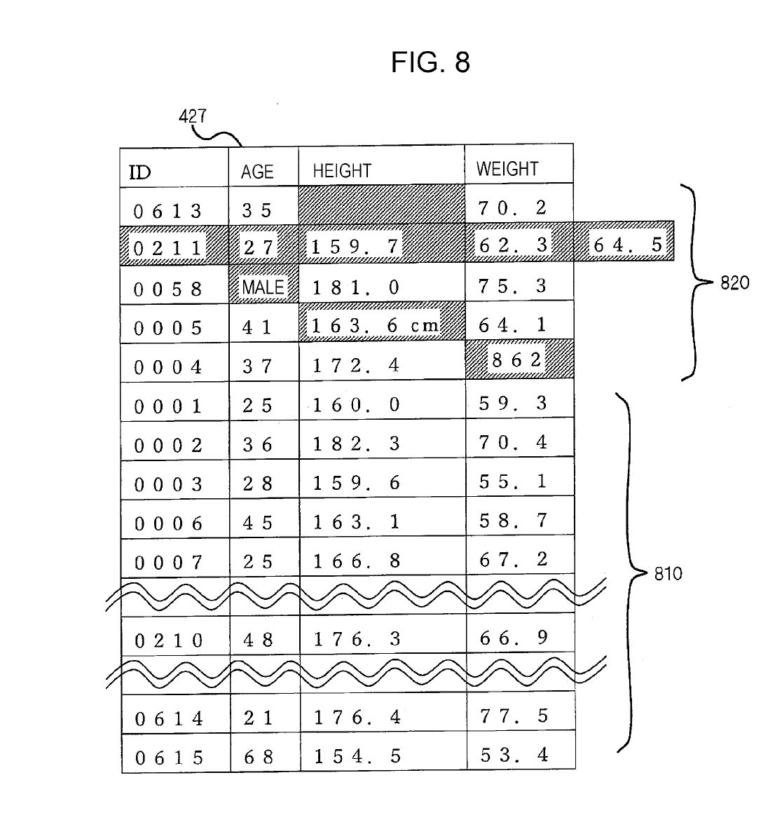

FIG. 8 illustrates a state of the sorted replicated database 427. As illustrated in FIG. 8, a plurality of records 820 that are moved by the sorting are inserted at higher places than a plurality of records 810 that are not moved by the sorting. Specifically, the record including the data entry in which the value of the column “ID” is “0004” is arranged at a place preceding (at a higher place than) the record including the data entry in which the value of the column “ID” is “0001”. In this record, the value “862” that is a statistical outlier is included in the data entry belonging to the column “weight”.

The record including the data entry in which the value of the column “ID” is “0005” (the data entry belonging to the column “height” includes characters “cm” corresponding to a data type different from the other data types) is arranged at a place preceding (at a higher place than) the record including the data entry in which the value of the column “ID” is “0004”. The record including the data entry in which the value of the column “ID” is “0058” (the data entry belonging to the column “age” includes “male” corresponding to a different data type) is arranged at a place preceding (at a higher place than) the record including the data entry in which the value of the column “ID” is “0005”. The record including the data entry in which the value of the column “ID” is “0211” (the number of columns is different from those of the other records) is arranged at a place preceding (at a higher place than) the record including the data entry in which the value of the column “ID” is “0058”. The record including the data entry in which the value of the column “ID” is “0613” (the column “height” is left blank (includes lost data)) is arranged at a place preceding (at a higher place than) the record including the data entry in which the value of the column “ID” is “0211”.

In the plurality of records 820 that are moved by the sorting in the sorted replicated database 427 of FIG. 8, the values of the column “ID” are arranged in descending order. The reason is as follows. When the replicated database 427 is sorted, the records are processed in ascending order. When a record including data having a property different from those of the other pieces of data is found, this record is moved to a highest place (top) in the replicated database 427 on this occasion. In the exemplary embodiment of the present disclosure, the pieces of data having properties different from those of the other pieces of data may be arranged in any order as long as the pieces of data are arranged at higher places in the replicated database 427. For example, the pieces of data may be arranged in ascending order. Alternatively, in accordance with a predetermined criterion, for example, the record in which the number of columns is different may be arranged at the top, the record in which the data type is different may be arranged at a second highest place, and the record including lost data may be arranged at a third highest place.

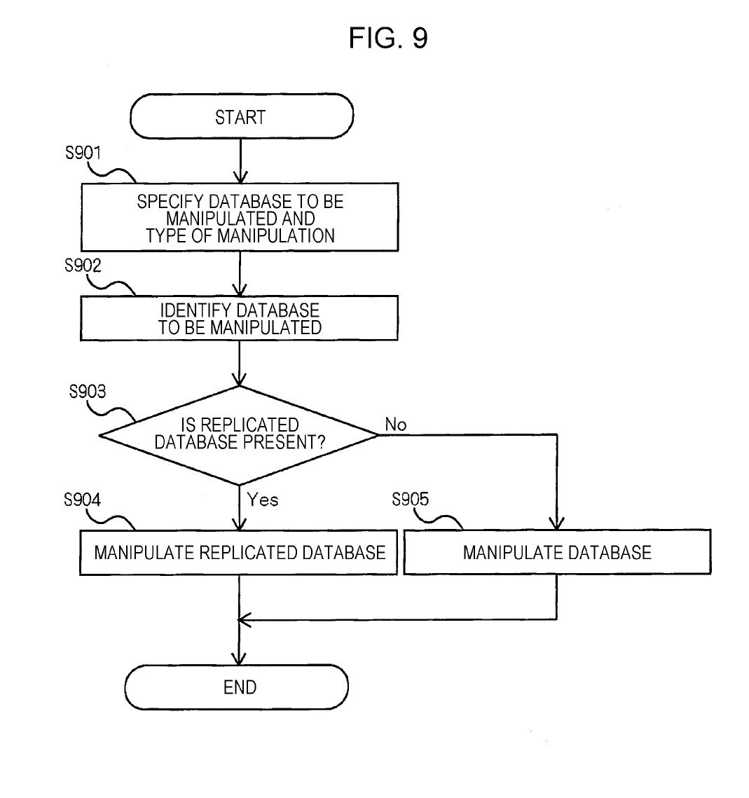

Next, a flow of manipulation of the sorted replicated database 427 according to this exemplary embodiment is described with reference to FIG. 9. FIG. 9 is a flowchart illustrating a flow of an operation to be performed when the information processing apparatus 20 manipulates the database 426 according to the exemplary embodiment of the present disclosure. In Step S901 of FIG. 9, the operator specifies or defines the database 426 to be manipulated and the type of manipulation to be performed on the database 426 by operating the input interface 206 of the information processing apparatus 20.

In Step S902, the database identifying part 221 identifies the database 426 to be manipulated that has been specified by the operator. It is assumed that the manipulation described below is started in response to an operator's instruction. The manipulation may automatically be executed subsequently to the sorting described with reference to FIG. 7. In Step S903, the database identifying part 221 refers to the association information 428 in the data storing part 425 of the data server 40 and determines whether the replicated database 427 associated with the database 426 is present. When it is determined that the replicated database 427 is present, the processing proceeds to Step S904. When it is determined that the replicated database 427 is not present, the processing proceeds to Step S905.

In Step S904, the manipulation part 226 manipulates the replicated database 427 corresponding to the database 426 identified by the database identifying part 221. When all the records that configurate the replicated database 427 have been manipulated, the processing is terminated. Examples of the manipulation include an operation of calculating values of the body mass index (BMI) by using the values of the data entries belonging to the column “height” and the values of the data entries belonging to the column “weight” in the replicated database 427 and adding the calculated values as values of a new column “BMI”. This manipulation is an example and other manipulation that uses the values of the respective data entries may be employed.

In Step S905, the manipulation part 226 manipulates the database 426 identified by the database identifying part 221. When all the records that configurate the database 426 have been manipulated, the processing is terminated. The manipulation is similar to the manipulation described above and is, for example, the operation of calculating values of the body mass index (BMI) by using the values of the data entries belonging to the columns “height” and “weight” and adding the calculated values as values of a new column “BMI”. The processing operation of Step S905 is performed when the replicated database 427 is not present. Therefore, instead of performing this manipulation, the replicated database 427 may be generated and sorted as described with reference to FIG. 7 and then manipulated in Step S904. Alternatively, when the replicated database 427 is not present, the processing may be terminated without performing the manipulation.

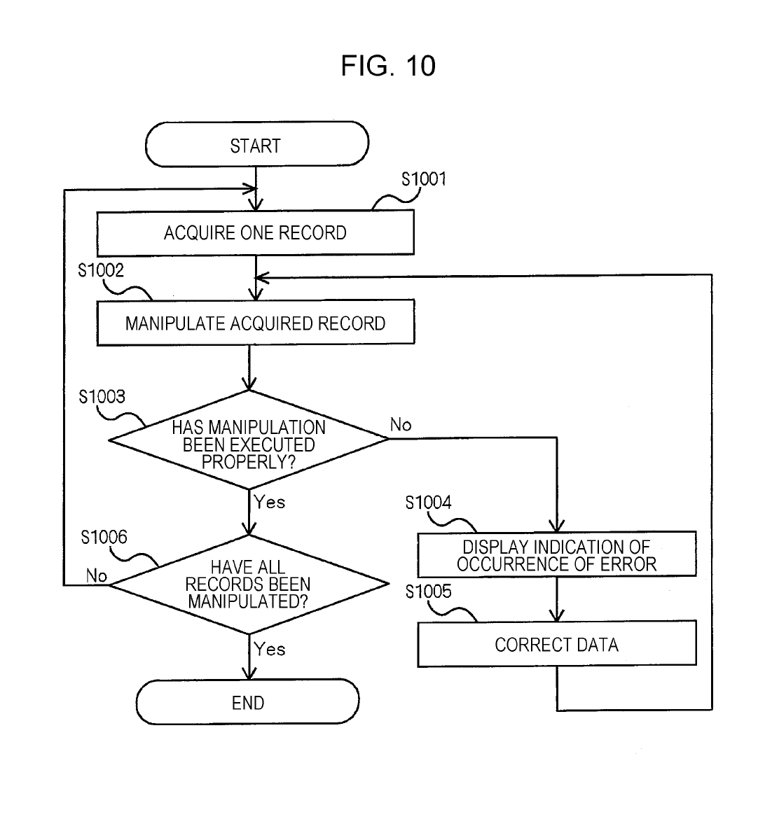

FIG. 10 is a flowchart illustrating a detailed flow of the manipulation of the replicated database 427 in Step S904 of FIG. 9 or the manipulation of the database 426 in Step S905. In Step S1001, the acquisition part 224 of the information processing apparatus 20 requests the data server 40 to acquire pieces of data of one unmanipulated record in the replicated database 427 or the database 426 identified as the database to be manipulated.

In response to the data acquisition request from the information processing apparatus 20, the data acquiring part 422 of the data server 40 acquires the pieces of data of one unmanipulated record from the replicated database 427 or the database 426 identified as the database to be manipulated and the data transmitting/receiving part 423 transmits the pieces of data to the information processing apparatus 20.

In Step S1002, the manipulation part 226 manipulates the pieces of data of one record acquired from the replicated database 427 or the database 426 in the data server 40. In the case of the database 426 or 427 illustrated in FIG. 6 or FIG. 8, the manipulation is the processing operation of calculating a value of the body mass index (BMI) by using the values of the data entries belonging to the columns “height” and “weight” in the database and adding the calculated value as a value of a new column “BMI”.

In Step S1003, the manipulation part 226 determines whether the manipulation of the record has been executed properly. When the manipulation has not been executed properly, the processing proceeds to Step S1004 and the display control part 227 generates an error message and displays the error message on the display 205. In Step 51005, the manipulation part 226 prompts the operator to correct data of the erroneous record. When the operator has corrected the data, the processing returns to Step S1002 and the manipulation is resumed.

When it is determined in Step S1003 that the manipulation has been executed properly, the processing proceeds to Step S1006. In Step S1006, the manipulation part 226 determines whether all the records in the replicated database 427 (database 426) to be manipulated have been manipulated. When all the records have been manipulated, the processing is terminated. When any unprocessed record is present, the processing returns to Step S1001 and the processing operations of Steps 51001 to S1006 are performed until all the records are manipulated.

The exemplary embodiment described above is directed to the example in which, when the operator of the information processing apparatus 20 has specified a certain database 426, the database 426 is replicated and the replicated database 427 is sorted. The replicated database 427 may be obtained by replicating the database 426 and the replicated database 427 may be sorted every time a predetermined number of pieces of data are registered in the database 426 specified by the operator, for example, every time 100 new records are added. Alternatively, the replicated database 427 may be obtained by replicating the database 426 and the replicated database 427 may be sorted at every predetermined time or at every predetermined time interval.

The exemplary embodiment described above is directed to the processing of generating the replicated database 427 corresponding to the specified database 426 and sorting the plurality of pieces of data in the replicated database 427. The plurality of pieces of data in the specified database 426 itself may be sorted. The specified database 426 may be stored in the information processing apparatus 20. The replicated database 427 may be stored in the information processing apparatus 20 or any other data server (not illustrated) connected to the network 30.

The above description is directed to the case of generating the replicated database 427 by replicating the entire database 426 and then sorting the replicated database 427. The exemplary embodiment of the present disclosure is not limited to this method. When the pieces of data of the records in the database 426 are sequentially acquired and the replicated database 427 is generated, a record including data having a different property may be moved to a higher place.

Contrary to the exemplary embodiment described above, the sorting part 225 may move, to a lower place in the database, data regarded as data having the same property as those of the other pieces of data.

When an error has occurred during the manipulation described above, the manipulation part 226 may record erroneous data. When the sorting part 225 has not determined that the data is data having a property different from those of the other pieces of data, the data, a data type corresponding to the data, or a data structure of a record including the data may be stored in the association information 428 so as to be regarded as the data having a property different from those of the other pieces of data and the record including the data may be moved to a higher place in the database at the time of next sorting.

As the database described above, description is made of the exemplary database configurated by results of a physical examination, such as “ID”, “age”, “height”, and “weight” of the columns. The database to be sorted in the exemplary embodiment of the present disclosure is not limited to this database but may be a database in a table format that is configurated by a plurality of columns and a plurality of records, such as an access log of a website or a sales record of a commercial facility.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
an acquisition unit that acquires a plurality of pieces of data to be handled; and
a sorting unit that sorts the plurality of pieces of data acquired by the acquisition unit so that data having a property different from properties of other pieces of data is located at a higher place.

2. The information processing apparatus according to claim 1, wherein the sorting unit moves data having a data structure different from data structures of the other pieces of data as the data having the property different from the properties of the other pieces of data.

3. The information processing apparatus according to claim 2, wherein the sorting unit moves data in which the number of data entries is different from the numbers of data entries of the other pieces of data as the data having the property different from the properties of the other pieces of data.

4. The information processing apparatus according to claim 2, wherein the sorting unit moves data whose data type is different from data types of the other pieces of data as the data having the property different from the properties of the other pieces of data.

5. The information processing apparatus according to claim 4, wherein the sorting unit moves data having a data entry including a character string compared with data entries including only numerals in the other pieces of data as the data having the property different from the properties of the other pieces of data.

6. The information processing apparatus according to claim 1, wherein, when a value of a certain data entry falls out of a value range that is identified by using the plurality of pieces of data and is appropriate for the pieces of data, the sorting unit moves data including the value as the data having the property different from the properties of the other pieces of data.

7. The information processing apparatus according to claim 6, wherein, when the value of the certain data entry falls out of a statistical range calculated by using the plurality of pieces of data, the sorting unit moves the data including the value as the data having the property different from the properties of the other pieces of data.

8. The information processing apparatus according to claim 6, wherein, when the value of the certain data entry is blank data, the sorting unit moves data including the blank data as the data having the property different from the properties of the other pieces of data.

9. The information processing apparatus according to claim 1, further comprising a processing unit that sequentially processes the plurality of pieces of data,
wherein, when the processing unit is instructed to process the plurality of pieces of data, the processing unit processes the plurality of pieces of data sorted by the sorting unit.

10. The information processing apparatus according to claim 2, further comprising a processing unit that sequentially processes the plurality of pieces of data,
wherein, when the processing unit is instructed to process the plurality of pieces of data, the processing unit processes the plurality of pieces of data sorted by the sorting unit.

11. The information processing apparatus according to claim 3, further comprising a processing unit that sequentially processes the plurality of pieces of data,
wherein, when the processing unit is instructed to process the plurality of pieces of data, the processing unit processes the plurality of pieces of data sorted by the sorting unit.

12. The information processing apparatus according to claim 4, further comprising a processing unit that sequentially processes the plurality of pieces of data,
wherein, when the processing unit is instructed to process the plurality of pieces of data, the processing unit processes the plurality of pieces of data sorted by the sorting unit.

13. The information processing apparatus according to claim 5, further comprising a processing unit that sequentially processes the plurality of pieces of data,
wherein, when the processing unit is instructed to process the plurality of pieces of data, the processing unit processes the plurality of pieces of data sorted by the sorting unit.

14. The information processing apparatus according to claim 6, further comprising a processing unit that sequentially processes the plurality of pieces of data,
wherein, when the processing unit is instructed to process the plurality of pieces of data, the processing unit processes the plurality of pieces of data sorted by the sorting unit.

15. The information processing apparatus according to claim 7, further comprising a processing unit that sequentially processes the plurality of pieces of data,
wherein, when the processing unit is instructed to process the plurality of pieces of data, the processing unit processes the plurality of pieces of data sorted by the sorting unit.

16. The information processing apparatus according to claim 8, further comprising a processing unit that sequentially processes the plurality of pieces of data,
wherein, when the processing unit is instructed to process the plurality of pieces of data, the processing unit processes the plurality of pieces of data sorted by the sorting unit.

17. The information processing apparatus according to claim 8, further comprising:
a replication unit that replicates the plurality of pieces of data acquired by the acquisition unit; and
a registration unit that registers, in a storage, association information in which the plurality of pieces of data acquired by the acquisition unit are associated with a plurality of pieces of data obtained through replication performed by the replication unit,
wherein, when the sorting unit is instructed to process the plurality of pieces of data, the sorting unit sorts the plurality of pieces of data obtained through the replication performed by the replication unit by using the association information registered by the registration unit.

18. An information processing system, comprising:
a specifying unit that specifies a storage location of a plurality of pieces of data to be handled;
an acquisition unit that acquires the plurality of pieces of data to be handled from the storage location specified by the specifying unit; and
a sorting unit that sorts the plurality of pieces of data acquired by the acquisition unit so that data having a property different from properties of other pieces of data is located at a higher place when processed.

19. A non-transitory computer readable medium storing a program causing a computer to execute a process comprising:
acquiring a plurality of pieces of data to be handled; and
sorting the plurality of pieces of acquired data so that data having a property different from properties of other pieces of data is located at a higher place when processed.
